(19) United States
(12) Patent Application Publication
(10) Pub. No.: US 2005/0182755 A1
(43) Pub. Date: Aug. 18, 2005

(54) Systems and methods for analyzing documents over a network

(76) Inventor: Bao Tran, San Jose, CA (US)

Correspondence Address: TRAN & ASSOCIATES, 6768 MEADOW VISTA CT., SAN JOSE, CA, 95135, US

(21) Appl. No.: 10/779,537

(22) Filed: Feb. 14, 2004

(51) Int. Cl. G06F 17/30

(52) U.S. Cl. 707/3

(57) ABSTRACT

Systems and methods are disclosed for mapping intellectual property by searching one or more remote databases for one or more relevant patents; and performing network analysis on the relevant patents.

### BACKGROUND

The present invention relates to systems and methods for analyzing documents.

The Internet has revolutionized the computer and communications world like nothing before. “Internet” refers to the global information system that—(i) is logically linked together by a globally unique address space based on the Internet Protocol (IP) or its subsequent extensions/follow-ons; (ii) is able to support communications using the Transmission Control Protocol/Internet Protocol (TCP/IP) suite or its subsequent extensions/follow-ons, and/or other IP-compatible protocols; and (iii) provides, uses or makes accessible, either publicly or privately, high level services layered on the communications and related infrastructure described herein. The Internet is at once a world-wide broadcasting capability, a mechanism for information dissemination, and a medium for collaboration and interaction between individuals and their computers without regard for geographic location.

The Internet has changed much in the two decades since it came into existence. It was conceived in the era of time-sharing, but has survived into the era of personal computers, client-server and peer-to-peer computing, and the network computer. It was designed before LANs existed, but has accommodated that new network technology, as well as the more recent ATM and frame switched services. It was envisioned as supporting a range of functions from file sharing and remote login to resource sharing and collaboration, and has spawned electronic mail and more recently the World Wide Web. But most important, it started as the creation of a small band of dedicated researchers, and has grown to be a commercial success with billions of dollars of annual investment.

The emergence of the Internet as the dominant communication medium is paralleled by the growth of intellectual property (IP). Due to the rapid dissemination of ideas over the Internet, businesses need protection for their proprietary developments. One type of IP is known as patents. A patent is a government grant formalized by an official document issued by a national patent office, including the US Patent & Trademark Office (USPTO), the European Patent Office (EPO), and the Japanese Patent Office (JPO), among others. By law, a patent has the attributes of personal property. The patent system has constitutional roots and is intended to promote the advancement of science and the useful arts. This advancement is promoted by granting limited exclusive rights to inventors in return for public disclosure of inventions. Public disclosure encourages scientific and technological advancement. In exchange for the public disclosure, the owner of a patent has the right to exclude others from making, using or selling the “patented invention” in the US, its possessions and territories. This right is enforceable against those who reverse engineer or independently develop the patented invention.

An individual may wish to study a patent for a variety of reasons. For example, once the individual has been made aware of a patent that may cover his or her product, the individual is under a duty to study the patent and cease making the product if it infringes. In other cases, the individual may wish to study the patent to better understand the prior art. In yet other cases, for expired patents, the individual may want to practice the patented invention. Alternatively, an individual may become aware of a particular patent number printed on a box for a patented product, or the individual may have heard news about a particular company's patent claims. Additionally, since each company is under a duty to avoid patent infringements, many companies perform “freedom to operate” studies prior to developing and commercializing a new product.

A particular patent can be located on-line: major patent offices such as the USPTO, the EPO and the JPO provide search engines to perform text search. Once relevant patents are identified, copies of these patents are retrieved. After getting a copy of the patent, the real work begins. Unless the reader is highly experienced with patents, reading and understanding the scope of a particular patent can be a painful undertaking. This is because a patented invention is defined by the claims which define the boundaries of an invention much like the description of property in a deed defines the boundaries of real estate. To determine precisely the “metes and bounds” of a patented invention, however, the patent specification, drawings, file history and “prior art” must also be reviewed. In general, unless litigation is anticipated, the patent is analyzed without the file history. Even when simplified, an analysis of a patent portfolio in an industry or product segment can involve numerous patents and prior art.

### SUMMARY

Systems and methods are disclosed for mapping intellectual property by searching one or more remote databases for one or more relevant patents; and performing network analysis on the relevant patents.

Advantages of the invention may include one or more of the following. The system automates the search for identifying relationships among patents. Patents are visually displayed for ease of interpretation. Each patent of interest is annotated, and the annotated document is easier to interpret since relevant information is parsed and visually provided to the user. Further, external information such as information from external documents and file history can be incorporated to ease interpretation.

### BRIEF DESCRIPTION OF THE DRAWINGS

FIG. 1 illustrates an exemplary environment with a document in accordance with one inventive system.

FIG. 2 illustrates an exemplary flow-chart.

FIG. 3 illustrates an exemplary document format.

FIG. 4 illustrates an exemplary annotation of the drawings or the claims of a patent document.

FIG. 5 shows one exemplary environment for IP analysis.

FIG. 6 shows one embodiment for handling patent requests from a client machine.

FIG. 7 shows one embodiment of a process to map intellectual property (IP).

FIGS. 8-9 show exemplary user interfaces for IP mappings.

FIG. 10 shows an exemplary process for caching IP documents on the server.

FIGS. 11-13 show exemplary processes for distributed mapping of IPs.

### DESCRIPTION

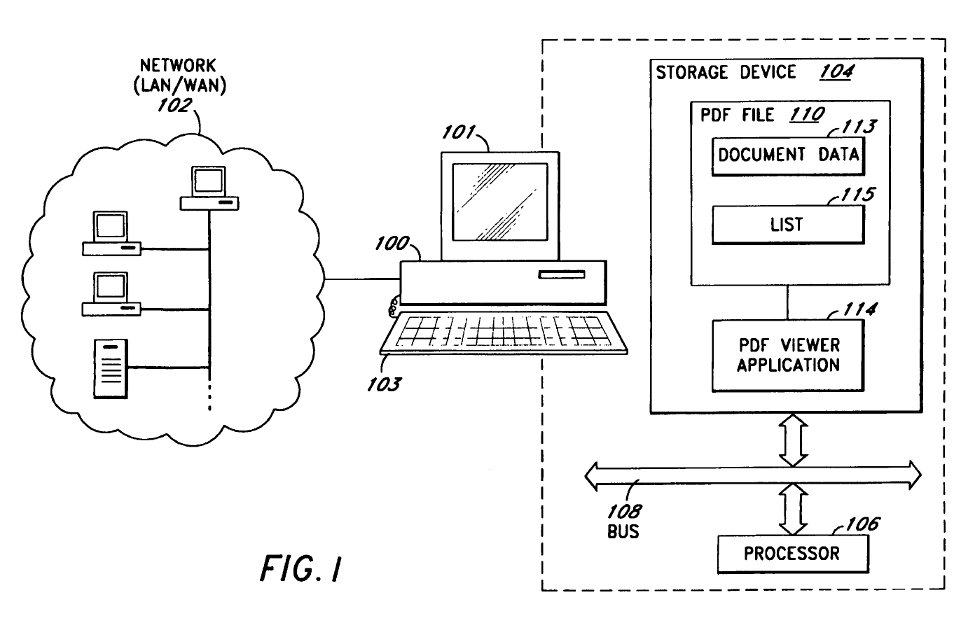

FIG. 1 illustrates an embodiment of a computer system with the method and apparatus of the present invention. A computer 100 has a display device, such as a monitor 101 and an input device, such as a keyboard 103. In one embodiment, the computer 100 may be coupled to a network 102 such as a local area network (LAN) or a wide area network (WAN). The network 102 is a possible mechanism for distribution of intellectual property (IP) related documents.

The computer 100 has a storage device 104 coupled to a processor 106 by a bus or busses 108. The storage device 104 has a document data 13 and one or more links 115 that provides additional information on the document data. The links 115 contains embedded information referencing one or more external documents viewable using a viewer application and information summarized from different section(s) or portion(s) of the document 13. In one embodiment, the link 115 is associated with the document 13 and is contained within the document 113.

The document 13 may be viewed through a viewer application 114 providing a graphical user interface (GUI). The links are programmatically enforced by the viewer application. In an alternate embodiment, the document 13 may be any type of electronic data.

In one embodiment, the document 113 is a portable document format (PDF). In this embodiment, the storage device 104 has a PDF file 110 that encapsulates the links 115. PDF is a file format utilized to represent a document in a manner independent of the application software, hardware and operating system used to create it. A PDF writer application converts operating system graphics and text commands to PDF operators and embeds them in a PDF file. The PDF files generated are platform independent and may be viewed by a PDF viewer application on any supported platform. Document data 113 in a PDF file 110 contains one or more pages, each page in the document containing a combination of text, graphics and images. Document data 113 may also contain information such as hypertext links, sound and movies. The recipient list 115 contains a list of recipients allowed access to the PDF file 110 document data 113.

The PDF file 110 may be browsed or viewed through a PDF viewer application 114 providing a graphical user interface (GUI). PDF viewer application 114 may be Adobe Acrobat Exchange or Acrobat Reader applications, both made available by Adobe Systems, Inc. of San Jose, Calif.

The file can receive permission attributes into the list 115 of links. The permission attributes identify varying levels of access to data contained in the PDF file 110 as provided to each recipient listed in the list 115. The PDF viewer application 114 accesses the permission attributes embedded in the list of links 115 to determine the level of access permission of a given recipient to a given PDF file 110. The permissions are programmatically enforced by the PDF viewer application 114.

The remainder of the detailed description will be described in reference to the preferred embodiment of the present invention illustrated in FIG. 1. However, it can be appreciated by a person skilled in the art that other equally applicable embodiments may be derived given the detailed description provided herein.

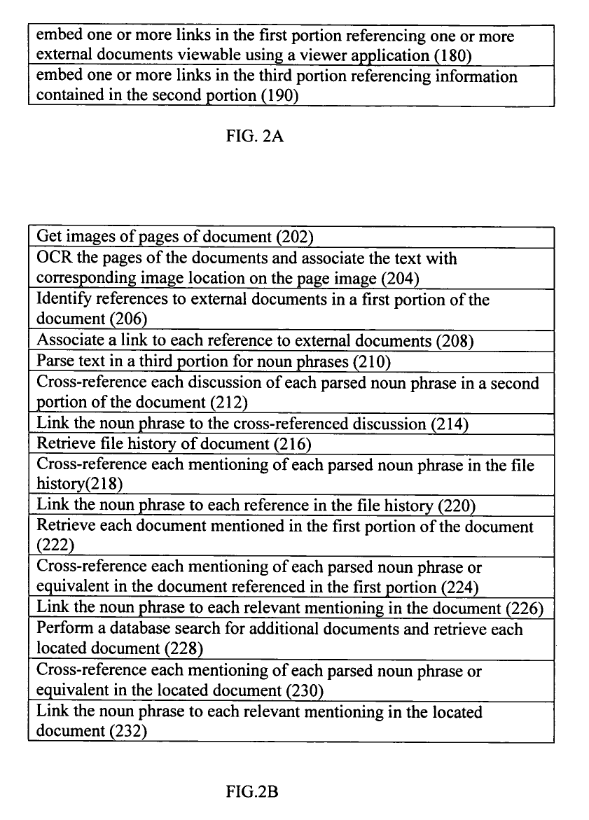

FIG. 2A shows one exemplary process for generating an electronic document in accordance with the invention. The process of FIG. 2A provides an electronic document having first, second and third portions by embedding one or more links in the first portion referencing one or more external documents viewable using a viewer application (180); and embedding one or more links in the third portion referencing information contained in the second portion (190).

In one embodiment, major structure of the document is shown in an outline that can be selected for quick navigation. Thus, a typical document may have an introduction section, a background section, drawings, description of the drawings, among others. The major structures are outlined and the user can easily navigate the document.

In one embodiment, if external documents are referenced, the links referencing external documents can be clicked upon by a user, and a new window opens and the external document is displayed. The link to the external document may be an identifier that can be searched and located from the Internet in one embodiment.

In another embodiment, the links in the third portion can be a link that points back to text in the second portion. When clicked, the user is taken to the appropriate text in the second portion. Alternatively, the links can be shown as PDF comments and/or bookmarks that can be used to navigate to the links.

In another embodiment, a summary of specific items mentioned in the document can be generated. The document may recite a number of items, for example a parts list and due to the numerosity, a summary list for the items may be useful for a reviewer to view. The summary can be placed in the PDF comment section or the PDF bookmark section, among others. When clicked, the user is transported to view the relevant section that mentions, refers, or discusses the item in the summary list.

In yet another embodiment, a navigation bar is provided to allow the user to move to the next item (forward), to go back to the previous item (backward), to go to the beginning (start), to go to the last section (end), or to fast forward and fast reverse, among others. Thus, using the summary list example, the user can use the navigation bar to navigate from the first mentioning of the item to the next mentioning of the item until the end is reached. Similarly, using the reference from the second portion that is mentioned in the third portion, the user can use the navigation bar to navigate the first mentioning of a particular term in the second portion. The user can move to the next mentioning of the term or the previous mentioning of the term.

FIG. 2B shows an exemplary process to generate the document 113 of FIG. 1. First, the process retrieves images of pages of document (202). Next, the process performs optical character recognition (OCR) on the pages of the documents and associates the text with corresponding image location on the page image (204). References to external documents in a first portion of the document are identified (206), and a link to each reference to external documents (208) is generated. With this link, a user can simply click on the title or any suitable mentioning of the external document and the external document will be retrieved and displayed for user review.

Next, the process of FIG. 2B parses text in a third portion for terminology such as text or noun phrases, among others (210). In one embodiment, the process cross-references each discussion of each parsed noun phrase in a second portion of the document (212). The process then links the noun phrase to the cross-referenced discussion (214). In this manner, the process shows consistent and/or inconsistent references to noun phrases in the third portion so that a user can quickly understand potential ambiguities in the document. Items mentioned in the drawings can also be cross-referenced.

In an optional operation, the process of FIG. 2B retrieves a file history of the document (216). The process then cross-references each mentioning of each parsed noun phrase in the file history (218). The noun phrase is linked to each reference in the file history (220). By showing the references to the noun phrases in the file history, the process shows consistent and/or inconsistent references to noun phrases in the third portion so that a user can quickly understand potential ambiguities in the document.

In yet another optional operation, the process of FIG. 2B retrieves each document mentioned in the first portion of the document (222). Each mentioning of each parsed noun phrase or equivalent in the external document is cross-referenced to the corresponding text in the first portion (224). The process then links the noun phrase to each relevant mentioning in the document (226). In this manner, the process of FIG. 2 identifies relevant references to the instant document from the external documents.

In another optional operation, the process performs a database search for additional documents and retrieves each located document (228). The search may locate data over the Internet or may locate data over an Intranet. The process cross-references each mentioning of each parsed noun phrase or equivalent in the located document (230) and links the noun phrase to each relevant mentioning in the located document (232). In this manner, the process of FIG. 2B identifies additional relevant references to the instant document by performing one or more searches.

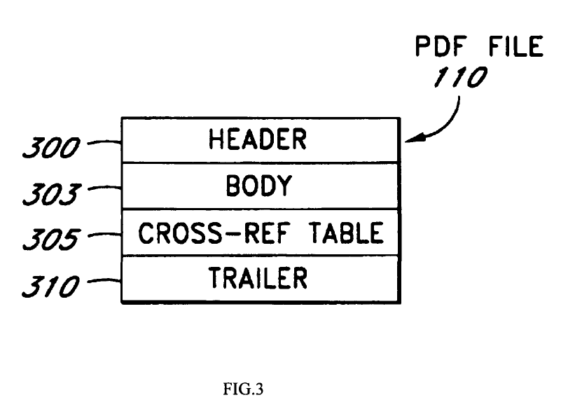

FIG. 3 illustrates an embodiment of the PDF file 110 file structure. A header 300 specifies the version number of the PDF specification to which the PDF file 110 adheres. A body 303 of a PDF file 110 consists of a sequence of indirect objects representing a document. The objects represent components of the PDF document, such as fonts, pages and sampled images. A cross-reference table 305 contains information which permits random access to indirect objects in the PDF file 110, such that the entire PDF file 110 need not be read to locate any particular object. Finally, a trailer 310 enables an application reading a PDF file 110 to quickly find the cross-reference table and to locate special objects.

The PDF file can be generated using a variety of tools such as SDKs from Adobe and Tracker Software. In one embodiment, Tracker Software's PDF-XChange is used. The tool allows the user to append to an existing PDF file (job management is now available & significantly improved); mount multiple source pages on a single output page; output to resolutions of up to 2400 DPI, varied paper sizes (PDF-Xchange supports the 42 most used paper formats+100 forms sizes may be added by the user, DPI now may be not only chosen from the standard list, but also set up manually in the wide range of 50-2400 dpi); manage embedded fonts; work with CJK fonts (PDF-XChange V3 supports fonts containing Unicode symbols for users requiring Chinese, Japanese and Korean (CJK) font compatibility.); design and add watermarks to the output; recognize/create bookmarks automatically; send created PDF documents immediately via e-mail using the internal built-in mailer (SMTP) or call the default system mailer (MAPI)—such as MS Outlook; save files to automated ‘Macro’ based file names and locations; call a viewer or software application after the file is created; create and use profiles to set the environment and setting according to different needs; and use Hot web URL links which are supported.

Next, an exemplary operation of an exemplary embodiment to generate a smart patent PDF file is discussed. In this embodiment, images of patent pages are retrieved. The images can be pulled from a proprietary database or can be pulled from various government web sites such as the USPTO (www.uspto.gov), the EPO (www.epo.org), the Korean Patent Office (www.kipo.go.kr), or the JPO (www.jpo.go.jp), or the Chinese State Intellectual Property Office (http://www.sipo.gov.cn) for example. The image of each page is OCRed and the resulting patent text is associated with corresponding image location on the page image.

In one embodiment, the patent images can be downloaded over the Internet. Alternatively, an original can be converted. The PDF Image and Searchable Text Conversion (formerly known as PDF plus hidden text) file contains a bitmapped image of the original, and a hidden layer of searchable text. The conversion process involves: scanning the hardcopy original, performing OCR (Optical Character Recognition) to capture the text of the document, and distilling the two layers into a PDF searchable image file. Though text can be searched, hyperlinks and bookmarks are not fully functional in this format. As with PDF image only, PDF searchable image files are only as legible as the original.

Alternatively, instead of OCRing the text, the patent number can be extracted, a search can be made at the corresponding government patent web site to locate the patent record. The patent record is in HTML or XML format, and the various portions of the patent can be separated and indexed. Then, text can be parsed and associated with the PDF document. The association can be position independent or dependent. In position independent embodiment, the location of the text is not aligned with its corresponding image location in the patent image. In position dependent embodiment, the location of the text is aligned with its corresponding image location in the patent image.

The process of can also search for matching claim phrases in external documents listed in a first portion of the patent (known prior art). Text in the known prior art is searched for noun phrases (or equivalent thereof) in the claims. Equivalency can be determined by looking up synonyms in a thesaurus, for example. Other ways of determining equivalency can be used as well. For example, from a corpus set of training patents, if certain words are statistically correlated and are likely to appear with other words, these words are considered to be equivalent and the search terminology can be expanded to include the original words as well as the equivalent words. The process cross-references each discussion of each parsed noun phrase in the external documents and links the words to the cross-referenced discussion. A similar process is performed for the file history of the patent being analyzed. Words that are important in construing the claims based on the file history are then identified for easy review. In addition to the file history, the system can perform a search for other prior art. The search can be carried out using a suitable search engine such as Google, for example, or can be carried out using the patent office search engines, among others. Each pertinent prior art found in the search is retrieved and links from the claim text are made to the newly located prior art.

In one embodiment, the process annotates drawings for user review. This is done by taking the item or part list which has been generated and associating the corresponding item name with the item number. Conversely, if the drawing mentions the item name but not the item number, the drawing can be annotated with the item number. As a result, the review or interpretation of the patent document can be made efficiently by avoiding manual annotation.

In yet another embodiment, the drawings can be annotated with the claim language. Since the user can comprehend images or drawings much faster than text, such annotation of the drawings can enhance review efficiency.

In yet another embodiment, the drawings can be annotated with citations to relevant prior art for ease of identifying novelty. In yet another embodiment, the citations to relevant prior art can be noted along with citations to the claim language.

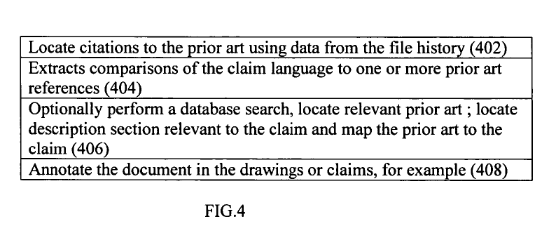

FIG. 4 illustrates an exemplary annotation of the drawings or the claims of a patent document. The process locates citations to the prior art using data from the file history (402); extracts comparisons of the claim language to one or more prior art references (404); and optionally performs a database search, locate relevant prior art; locate description section relevant to the claim and map the prior art to the claim (406) Annotate the document in the drawings or claims, for example (408). The citations to the prior art can be done using data from the file history. In this embodiment, the process extracts comparisons of the claim language to one or more prior art references. Each comparison is noted on the document. Alternatively, the process can perform a database search, locate relevant prior art, and annotate the document appropriately. The database search can be a linguistic search that searches for the terminology, for the concepts, or a combination of both. The linguistic search can also be done using one or more languages such as English, Germany, Japanese, or Chinese, among others.

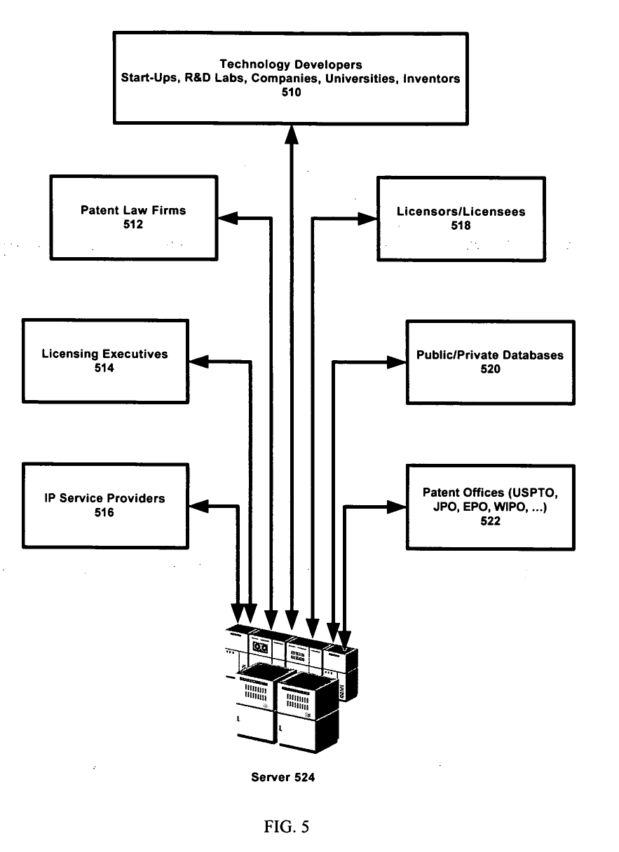

FIG. 5 shows one exemplary environment for IP analysis. In FIG. 5, one or more Technology Developers such as Start-Ups, R&D Labs, Companies, Universities, and Inventors 510 communicate with a server 524. Additionally, Patent Law Firms 512, Licensing Executive Firms 514, IP Service Providers 516, Licensors or Licensees 518, Databases (such as Lexis Nexis or Westlaw) 520, and Patent Offices 522 communicate with the server 524. The server 524 receives requests from one or more clients, and searches its internal databases and/or resources from the patent offices 522, IP providers 516, public/private databases 520 and any other information available to respond to the requests.

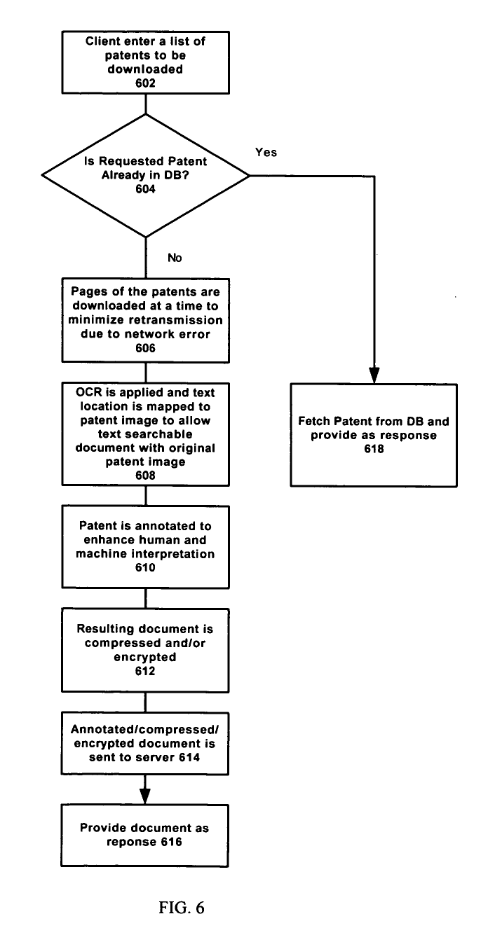

The requests may include requests for copies of a particular patent. In response, the processes of FIGS. 1-4 may be used to satisfy the request. When there are many users that are likely to make requests for the same patent document, caching can be used to minimize network burden on the source. FIG. 6 shows one embodiment for handling patent requests from a client machine. The process receives a list of patents to be downloaded (602) as specified at the client machine. The process checks databases on the remote server to see if the requested patent is already cached or stored at the remote server (604). If so, the process fetches the database and provides the copy as the response to the request (618). If the patent is not cached or stored in the server already, the client machine starts a download process for the patent from one of sources 520 or 522 as appropriate. Operations 606-616 occur at the client machine. The process can download the entire patent at a time, or, since network failures may occur for large files, the process downloads each page of the patent separately to minimize retransmission due to network failure (606). In one embodiment, OCR processing is applied to the image to extract text from the image of the patent, and the location of each text is mapped to the image (608). In this manner, text searchable patent document can be created. Next, the patent is annotated to enhance human as well as machine interpretation (610), one embodiment is shown in FIG. 4. The resulting document is compressed and optionally encrypted (612). Since the document is not already on the server, the document is sent back to the server to be cached (614) to satisfy another request for the patent. Finally, the process provides the document to the user in satisfaction of the request (616).

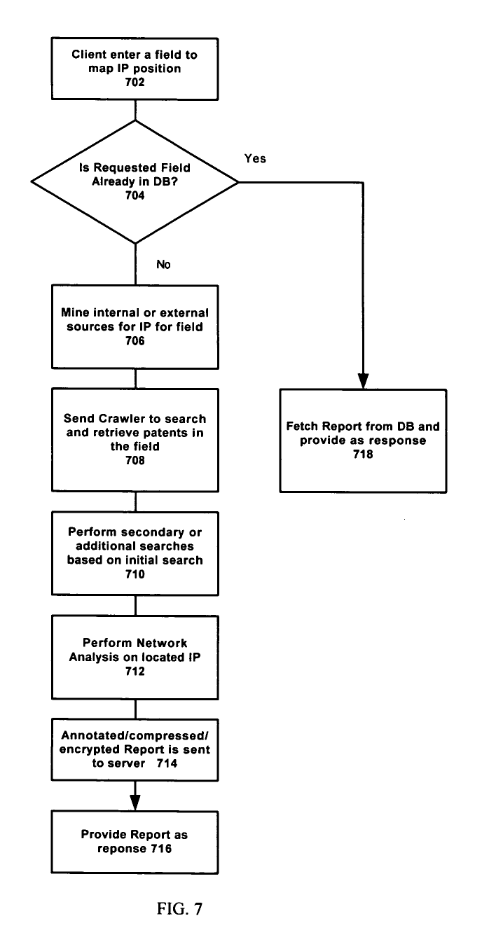

FIG. 7 shows one embodiment of a process to map intellectual property. First, a user enters at a local machine one or more search queries to indicate the area to be mapped (702). For example, the user may enter “car” to indicate that the auto industry IP portfolio is to be mapped. The user can also enter Chrysler to indicate that Chrysler's IP portfolio is to be analyzed. The process checks with the remote server to see if an identical search request has been done before (704). If so, the result response to the search query is provided as a response (718). If not, operations 706-716 are performed by the client machine. First, the client machine issues one or more search requests directed at one or more databases and mine data relating to the search query (706). For example, the client may search a patent office database and locate patents responsive to the search query. A crawler can be sent to search and retrieve patents in the field of interest (708). The process can perform secondary or additional searches based on the initial search (710).

Next, network analysis is performed on the search result in one embodiment (712). Network analysis can generate sociograms (network diagrams) to visualize the networks being analyzed. One technique to draft a sociogram is to construct it around the circumference of a circle. The circle helps organize the data, but the order in which the points is determined only by an attempt to keep the number of lines connecting the various points to a minimum. Typically, a trial-and-error drafting process is used until an aesthetically pleasing result is achieved. While such a process can make the structure of relations clearer, the relations between the sociogram's points reflect no specific mathematical properties. The points are arranged arbitrarily and the distances between them are meaningless. A number of techniques (e.g., metric and non-metric multidimensional scaling, correspondence analysis, spring-embedded algorithms, etc.) that mathematically represent the points in space can be used.

The analysis is stored in a document, which can be compressed and optionally encrypted (714). Since the document is not already on the server, the document is sent back to the server to be cached (716) to satisfy another request for the patent. Finally, the process provides the document to the user in satisfaction of the request (718).

Pseudo-code for one exemplary IP mapping system is as follows:
1. Receive two keyword boxes (K1 and K2) and assignee table for list of Y competitors in a Y×1 column
2. Build search command for all patents with keywords K1 and K2 and assignees (Y1 or Y2 or . . . or Yn)
3. run search command in Issued Patent DB and Published Application DB
4. Allow the user to review search result and revise search if needed
5. Download all text for all search results and parse into sections
6. Extract cited prior art patents for all search results and create a common unique list of prior art patents
7. Identify patents not in the search results and update list of assignee for these patents to YS1.
8. Run search in Issued and Published Application DBs with command: keywords K1 and K2 and assignees YS1 or YS2 or . . . YSn and downloaded/parsed into sections
9. For each patent, create spring relationship among patents based on number of citation of patent prior art. Generate spring mass diagram. Allow user to play with the spring mass. For each patent, he can view each section of the patent, see PDF or TIFF versions.
10. Clusterize according to word similarity
11. Provide graphics wizard to easily generate a view of IP space for display, plot on a large format plotter or 3D virtualization.

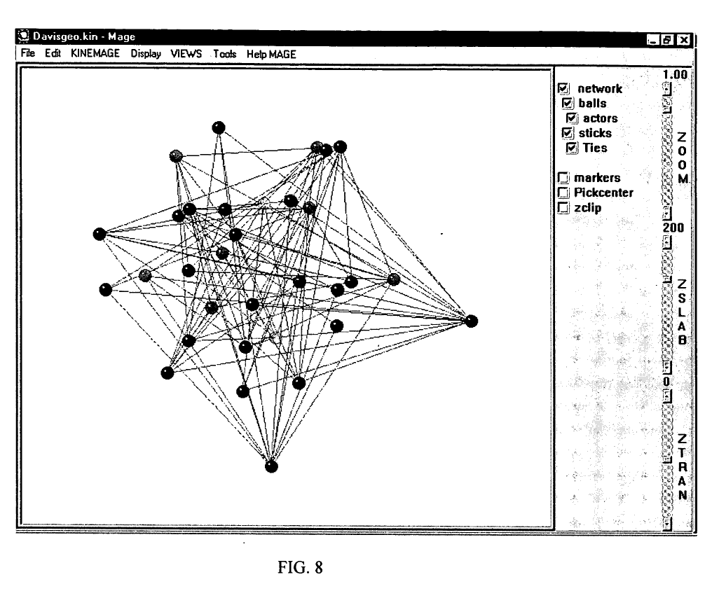

FIGS. 8-9 show exemplary mappings of IPs. In the exemplary display of FIG. 8, each patent is represented as a sphere. In FIG. 9, the patents are arranged as hyperbolic trees.

In the embodiment of FIG. 8, the rendering tool is MAGE. The user may maneuver the view using three control bars: “ZOOM,” “ZSLAB” and “ZTRAN.” The “ZOOM” bar allows users to “move” the object closer or farther away. The “ZSLAB” bar controls contrast while the “ZTRAN” bar controls brightness. Also along the right side of the screen are a series of “switches” that allow users to turn particular features (e.g., nodes, labels, ties) of the image off or on and thereby call attention to various structural properties. Users can rotate the image. Such rotation can potentially uncover structural regularities that may not be readily observable at first glance. The colors of the nodes, ties and labels can be changed as well.

In another embodiment, the patent mapping can also be a virtual 3D environment where the user is placed in a virtual environment to enable the user to manipulate and explore IP relationships. In yet other embodiments, the patent mapping can also be a haptic interface, that is, interface which provides a touch-sensitive link between a physical haptic device and an electronic environment. With a haptic interface, a user can obtain touch sensations of surface texture and rigidity of electronically generated virtual objects, such as may be created by a computer-aided design (CAD) system. Alternatively, the user may be able to sense forces as well as experience force feedback from haptic interaction with an electronically generated environment. A haptic interface system typically includes a combination of computer software and hardware. The software component is capable of computing reaction forces as a result of forces applied by a user “touching” an electronic object. The hardware component is a haptic device that delivers and receives applied and reaction forces, respectively. Existing haptic devices include, for example, joysticks (such as are available from Immersion Human Interface Corporation, San Jose, Calif.; further information is available at www.immerse.com, the disclosure of which is incorporated herein by reference for all purposes), one-point probes (such as a stylus or “spacepen”) (such as the PHANToM™ product available from SensAble Technologies, Inc., Cambridge, Mass.; further information is available at www.sensable.com, the disclosure of which is incorporated herein by reference for all purposes) and haptic gloves equipped with electronic sensors and actuators (such as the CyberTouch product available from Virtual Technologies, Inc., Palo Alto, Calif.; further information available at www.virtex.com, incorporated herein by reference for all purposes).

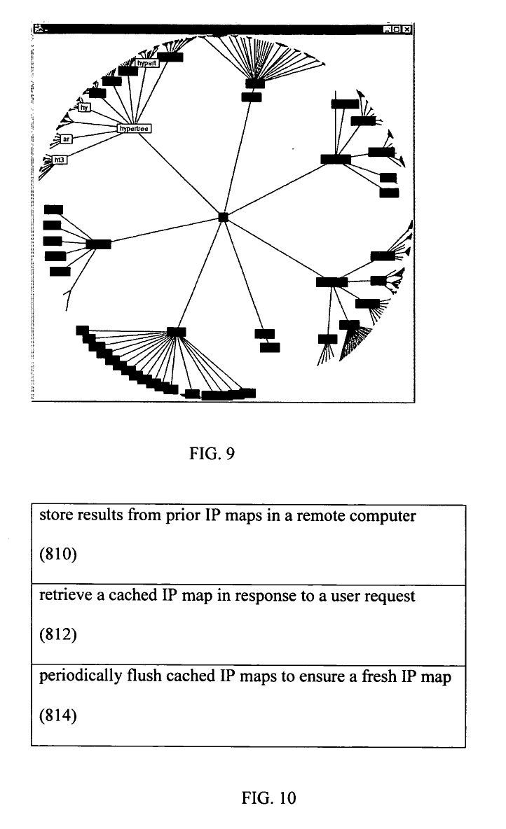

FIG. 10 shows an exemplary process for caching IP documents on the server. The process stores results from prior IP maps in a remote computer (810). It also retrieves a cached IP map in response to a user request if the patent number matches one of the cached IP documents (812). The process also periodically flushes cached IP maps to ensure a fresh IP map (814).

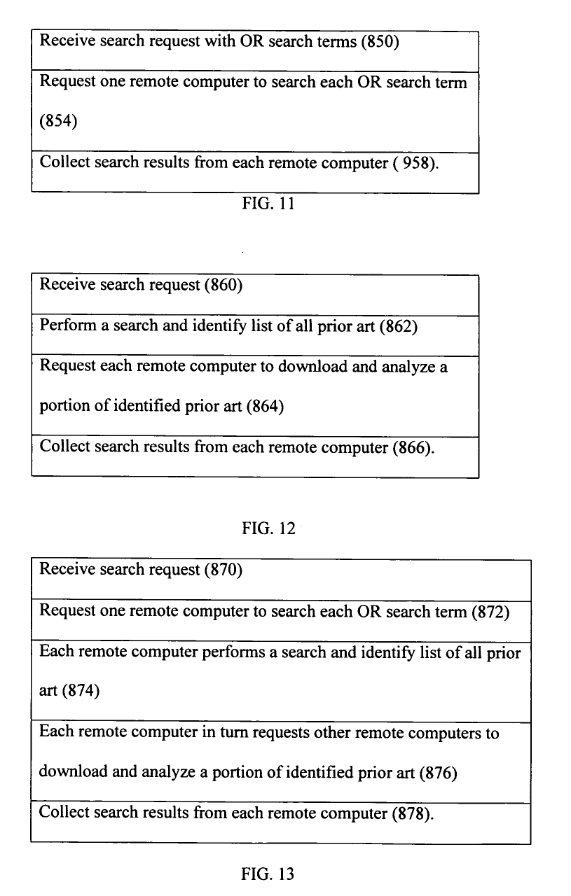

FIG. 11 shows an exemplary process for distributed mapping of IPs. The process receives search request with OR search terms (850); requests one remote computer to search each OR search term (854) and collects search results from each remote computer (958).

FIG. 12 shows a second embodiment of distributed mapping. The process receives a search request (860). It performs a search and identify list of all prior art (862). The process then requests each remote computer to download and analyze a portion of identified prior art (864). The process collects search results from each remote computer (866).

FIG. 13 shows a third embodiment of distributed mapping. The process receives search request (870); requests one remote computer to search each OR search term (872). Each remote computer performs a search and identify list of all prior art (874). Each remote computer in turn requests other remote computers to download and analyze a portion of identified prior art (876). The process then collects search results from each remote computer (878).

One type of network can be associative networks. The associative networks used in the system are Pathfinder networks (PNets). The Pathfinder algorithm was developed to model semantic memory in humans and to provide a paradigm for scaling psychological similarity data. A number of psychological and design studies have compared PFNETs with other scaling techniques and found that they provide a useful tool for revealing conceptual structure. The PfNet representations underlying the system's network displays are minimum cost networks derived from measures of term and document associations. The network of documents is based on interdocument similarity, as measured by co-occurrence of keywords between document pairs. For the network of terms, or associative term thesaurus, the visual representation of the user's query, and single document representations the associations are derived from text with association measured by keyword co-occurrence and lexical distance within documents. PfNets can be conceptualized as path length limited minimum cost networks. Algorithms to derive minimum cost spanning trees (MCSTs) have only the constraints that the network is connected and cost, as measured by the sum of link weights, is a minimum. For PfNets, an additional constraint is added: Not only must the graph be connected and minimum cost, but also the longest path length to connect node pairs, as measured by number of links, is less than some criterion. To derive a PfNet direct distances between each pair of nodes are compared with indirect distances, and a direct link between two nodes is included in the PfNet unless the data contain a shorter path satisfying the constraint of maximum path length.

In constructing a PfNet two parameters are incorporated: r determines path weight according to the Minkowski r-metric and q specifies the maximum number of edges considered in finding a minimum cost path between entities. As either parameter is manipulated, edges in a less complex network form a subset of the edges in a more complex network. Thus, the algorithm generates two families of networks, controlled by r and q. The least complex network is obtained with r=infinity and q=n-1, where n is the total number of nodes in the network. The containment property has in practice provided a particularly useful technique for systematically varying network density to provide both relatively sparse networks (the union of MCSTs with r =infinity and q=n-1) for global navigation, as well as more dense networks for local inspection.

In addition to the query and document term displays the user can access two other visually displayed network structures: an associative thesaurus of terms, and a network of documents. The associative thesaurus is based on a PFNET of all terms in the database. The distances for deriving this network are found using the same weighted co-occurrence measure used in assigning term distances in documents and queries. All documents are analyzed and an additional value is added to term pair similarity is for terms co-occurring in the same document. For the network of documents, distances between documents are calculated using the same matching algorithm used to assess query-document similarity. Network similarity is calculated by combining the number of commons terms with a measure of structural similarity for these common terms.

In one embodiment, overview diagrams are used to supply a user with (1) knowledge about the organization of the complete network, (2) a means for navigating the network, and (3) orientation within the complete network. In overview diagrams a small number of nodes, selected to provide information about the organization of the complete network, are displayed to the user. Additionally, the nodes typically provide entry points for traversing the network. These nodes provide orientation by serving as landmarks to assist the user in knowing what part of the network is currently being viewed.

Alternatively, techniques such as hyperbolic trees can be used to visualize relationship among patents. The patent documents can be represented as trees, including structured documents, directories, and some kinds of hypertext (those that have no cyclic links). A tree is drawn as large as it needs to be and then render an image that is controlled with scroll bars. This process has the problem that the user is prevented from seeing the overall structure and must keep most of a large space in memory rather than in view. Trees are useful for representing large collections of documents, but single documents are also amenable to tree representations if the underlying structure of the document is hierarchical. There is a movement toward representing text structurally. SGML is a prime example of an effort to systematize document structure. Editors that are used to create SGML-compliant text maintain document structure as trees. In SGML trees, the content of a document resides in the leaf nodes of the tree.

Many views of documents can be thought of as networks. Queries, semantic networks, associative thesaurus and hypertexts can all be represented as networks. Multidimensional data, discussed above, differ qualitatively from network data in that the latter have dependencies among the parts. Multidimensional scaling methods tend to drive concepts apart, i.e., to find orthogonal dimensions, while networks assume dependencies among the concepts being manipulated.

Network displays can represent more general and more complicated structures than hierarchical displays. The complexity of the information spaces when expressed as networks can be difficult for users to comprehend. A major issue then is how to simplify such displays without losing critical information. One method for reducing complexity is to reduce the dimensionality of the space. Latent semantic indexing (LSI) is a method can be applied to reducing dimensionality.

Hyperbolic graph layout uses context and focus technique to represent and manipulate large tree hierarchies on limited screen size. Hyperbolic trees are based on Poincare's model of the (hyperbolic) non-Euclidean plane. The hyperbolic layout employs a Radical Layout: Conventionally, trees are displayed on an Euclidean plane with the root at the top and children below their parents and connected to their parents with edges. The hyperbolic layout uses a radical layout. The root is placed at the center while the children are placed at an outer ring to their parents. The circumference jointly increases with the radius and more space becomes available for the growing numbers of intermediate and leaf nodes. The hyperbolic layout also uses a Distortion Technique where the hyperbolic layout uses a nonlinear (distortion) technique to accommodate focus and context for a large number of nodes. To ensure that nodes do not overlap each other, hyperbolic layout algorithms assign an open angle for each node. All children of a node are laid out in this open angle. Transformations are provided to allow fluent node repositioning. User can click on a node to move it to the center or to grab and reposition a single node. While traditional methods such as paging (divides data in to several pages and display one page at a time) zooming, or panning show only part of the information at a certain granularity, hyperbolic trees show detail and context at once.

Although the foregoing relates to an issued patent document, the same can be applied to pending applications as well. Also, the analysis process and embedding of information are applicable to a number of patent offices including the USPTO, EPO, JPO, and KIPO, among others. Further, although PDF is mentioned as one embodiment, other document formats are contemplated. Examples of such document formats include Microsoft's XDoc, HTML documents, XML documents, TIFF documents, JPEG documents, and multimedia documents, among others. XDocs (InfoPath) is Microsoft's new XML-based forms and document solution. XDocs is optimized for the Microsoft Office System, picture it as an ecosystem that represents a combination of familiar and easy-to-use programs, servers and services that are intended to help information workers address a broader array of business challenges. It encompasses the core Microsoft Office client applications, as well as FrontPage 2003, Visio 2003, Project 2003 and Publisher 2003, as well as new desktop applications, InfoPath 2003 and OneNote 2003. With the addition of servers, such as SharePoint Portal Server 2003, Project Server 2003 and the Live Communications Server 2003, users will be able to take advantage of deeper collaboration capabilities and communication tools like live chats within familiar productivity applications right from their PCs.

While certain exemplary embodiments have been described in detail and shown in the accompanying drawings, it is to be understood that such embodiments are merely illustrative of and not restrictive on the broad invention, and that this invention is not to be limited to the specific arrangements and constructions shown and described, since various other modifications may occur to those with ordinary skill in the art.

1. A method for mapping intellectual property, comprising:
searching one or more remote databases for one or more relevant patents; and
performing a network analysis on the relevant patents.

2. The method of claim 1, further comprising receiving as a query one or more keywords or assignees to be searched;
searching the query in Issued Patent or Published Application databases;
retrieving cited prior art patents for each patent found in search results;
updating the query by adding assignees from the cited prior art patents; and
running a second search using the updated query.

3. The method of claim 1, further comprising:
for each patent, creating spring relationship among patents based on number of citation of patent prior art; and
generating a spring mass diagram.

4. The method of claim 1, further comprising clusterizing patents according to word similarity.

5. The method of claim 1, further comprising generating a visualization of the patents for display on a screen or plotting on a large format plotter.

6. The method of claim 1, further comprising three-dimensionally visualizing the patents on a 3D display device.

7. The method of claim 1, further comprising allowing a user to review the search result and revise the query.

8. The method of claim 1, further comprising caching results from prior IP maps in a remote computer.

9. The method of claim 8, further comprising retrieving a cached IP map in response to a user request.

10. The method of claim 8, further comprising periodically flushing cached IP maps to ensure a fresh IP map.

11. The method of claim 1, further comprising distributing a search over a plurality of client computers.

12. The method of claim 11, wherein one of the client computers is located behind a firewall, further comprising bypassing the firewall in sending distributed search results to a remote computer.

13. The method of claim 1, further comprising annotating a patent at a local computer and caching the annotated patent at a remote computer to satisfy a subsequent request for said patent.

14. A method for mapping intellectual property, comprising:
(a) receiving as a query one or more keywords or assignees to be searched;
(b) searching the query in Issued Patent or Published Application databases;
(c) retrieving cited prior art for each patent found as search results;
(d) updating the query by adding assignees from the cited prior art; and
(e) iteratively repeating (b)-(d) using the updated query.

15. The method of claim 14, further comprising network analyzing the search results.

16. A system for mapping intellectual property, comprising:
means for searching one or more remote databases for one or more relevant patents; and
means for performing a network analysis on the relevant patents.

17. The system of claim 16, further comprising means for generating a computer-readable intellectual property mapping file.

18. The system of claim 17, wherein the IP mapping file comprises:
a collection of patent documents, each having one or more links embedded in the first portion referencing one or more external documents viewable using a viewer application; and one or more links embedded in the third portion referencing information contained in the second portion; and
links generated by a network analysis of relationships among the patent documents.

19. A computer readable media containing executable computer program instructions which when executed on a digital processing system causes the system to perform a method comprising:
receiving as a query one or more keywords or assignees to be searched;
searching the query in Issued Patent or Published Application databases;
retrieving cited prior art patents for each patent found in search results;
updating the query by adding assignees from the cited prior art patents;
running a second search using the updated query; and performing a network analysis on the search results.

20. The media of claim 19, further comprising instructions to distribute the processing over a plurality of computers.
